(19) United States
(12) Patent Application Publication
(10) Pub. No.: US 2019/0188729 A1
(43) Pub. Date: Jun. 20, 2019

(54) SYSTEM AND METHOD FOR DETECTING COUNTERFEIT PRODUCT BASED ON DEEP LEARNING

(71) Applicants: Beijing Jingdong Shangke Information Technology Co., Ltd., Beijing (CN); JD.com American Technologies Corporation, Santa Clara, CA (US)

(72) Inventors: Hongda Mao, Fremont, CA (US); Chi Zhang, Fremont, CA (US); Weidong Zhang, San Jose, CA (US); Hung-Shuo Tai, San Jose, CA (US); Chumeng Lyu, Santa Clara, CA (US)

(21) Appl. No.: 15/846,185

(22) Filed: Dec. 18, 2017

(51) Int. Cl. G06Q 30/00; G06N 99/00; G06T 7/00; G06K 9/66; G06K 9/46; G06K 9/62

(52) U.S. Cl. CPC G06Q 30/018; G06N 99/005; G06T 7/0002; G06T 2210/12; G06K 9/46; G06K 9/6202; G06K 9/66

(57) ABSTRACT

A system for validating a product incudes a computing device having a processor and a non-volatile memory storing computer executable code. The executed code is configured to: receive an instruction from a user when a user views a media file corresponding to the product; upon receiving the instruction, obtain a copy of the media file; process the copy of the media file using a deep learning module to obtain an identification of the product; and validate the product by comparing the identification of the product with a stored identification corresponding to the product. The deep learning module includes convolution layers for performing convolution on the copy of the media file to generate feature maps; a detection module for receiving the feature maps and generating intermediate identifications of the product; and a non-maximum suppression module for processing the intermediate identifications of the product to generate the identification of the product.

### CROSS-REFERENCES

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### FIELD OF THE INVENTION

The present invention relates generally to object recognition technology, and more particularly to systems and methods for detecting counterfeit product by deep learning.

### BACKGROUND OF THE INVENTION

The background description provided herein is for the purpose of generally presenting the context of the invention. Work of the presently named inventors, to the extent it is described in this background section, as well as aspects of the description that may not otherwise qualify as prior art at the time of filing, are neither expressly nor impliedly admitted as prior art against the present invention.

Existence of counterfeit products impairs interest of customers, and increases cost and damages reputation of product providers. However, it is challenging to identify a counterfeit product from a large number of products available in a market.

Therefore, an unaddressed need exists in the art to address the aforementioned deficiencies and inadequacies.

### SUMMARY OF THE INVENTION

In certain aspects, the present invention relates to a system for validating a product.

The system has a computing device. The computing device has a processor and a non-volatile memory storing computer executable code. The computer executable code, when executed at the processor, is configured to:
receive an instruction from a user, where the instruction is generated when a user views a media file corresponding to the product;
upon receiving the instruction, obtain a copy of the media file;
process the copy of the media file using a deep learning module to obtain an identification of the product; and
validate the product by comparing the identification of the product with a stored identification corresponding to the product.

In certain embodiments, the product to be validated is the one listed by one or more e-commerce platforms.

In certain embodiments, the deep learning module includes:
a plurality of convolution layers sequentially in communication with each other, where the number of layers can vary between 5 to 1000 depending on the applications, each layer can be considered as a feature extractor, and the features extracted by the convolutional layers are from fine to coarse corresponding to the layers from bottom to top (or left to right sequentially), after feature extraction, each of the convolution layers generates a feature map of the extracted features;
a detection module, configured to receive multi-scale feature maps from aforementioned convolution layers, and detects object candidates from the feature maps; and
a non-maximum suppression module, configured to refine and generate the identification of the product based on the intermediate identifications of the product at detection module.

In certain embodiments, the data used for training the deep learning module comprise an image, at least one bounding box location, and at least one logo label corresponding to the at least one bounding box.

In certain embodiments, the deep learning module is trained using a plurality set of training data, wherein each set of the training data comprises an image, at least one bounding box location in the image, and at least one logo label corresponding to the at least one bounding box.

In certain embodiments, the computing device is at least one of a server computing device and a plurality of client computing devices, the server computing device provides service of listing the product, and the client computing device comprises a smartphone, a tablet, a laptop computer, and a desktop computer. In certain embodiments, the server computing device provides service of one or more e-commerce platforms.

In certain embodiments, the copy of the media file is obtained from the server computing device.

In certain embodiments, the instruction is generated when a user clicks an image or a video corresponding to the media file.

In certain embodiments, the identification of the product comprises a brand name or a logo image of the product.

In certain embodiments, the computer executable code, when executed at the processor, is further configured to: when the identification of the product does not match with the stored identification of the product, send a notice to at least one of the user and a manager of the product, such as the user and the manager of the e-commerce platform.

In certain aspects, the present invention relates to a method for validating a product. In certain embodiments, the product is listed by an e-commerce platform. In certain embodiments, the method includes the steps of:
receiving an instruction at a computing device, wherein the instruction is generated when a user views a media file corresponding to the product;
upon receiving the instruction, obtaining a copy of the media file;
processing the copy of the media file using a deep learning module to obtain an identification of the product; and
validating the product by comparing the identification of the product with a stored identification corresponding to the product.

In certain embodiments, the deep learning module processes the copy of the media file by:
performing convolution on the copy of the media file to generate feature maps having multi-scale by a plurality of convolution layers sequentially in communication with each other, where each of the convolution layers extract features from the copy of the media file or the feature map from the immediate previous convolution layer to generate the corresponding feature map;
receiving and processing the multiple-scale feature maps to generate intermediate identifications of the product; and
generating the identification of the product based on the intermediate identifications of the product.

In certain embodiments, the features comprise images, at least one bounding box location, and at least one logo label corresponding to the at least one bounding box.

In certain embodiments, the method further includes the step of: training the deep learning module using a plurality set of training data, wherein each set of the training data comprises images, at least one bounding box location in the image, and at least one logo label corresponding to the at least one bounding box.

In certain embodiments, the computing device is at least one of a server computing device that provides service of the product, and a plurality of client computing devices, and the client computing device comprises a smartphone, a tablet, a laptop computer, and a desktop computer. In certain embodiments, the server computing device provides one or more e-commerce platforms.

In certain embodiments, the copy of the media file is obtained from the server computing device.

In certain embodiments, the method further includes the step of: when the identification of the product does not match with the stored identification corresponding to the product, send a notice to at least one of the user and a manager, such as the user and the manager of the e-commerce platform.

In certain aspects, the present invention relates to a non-transitory computer readable medium storing computer executable code. The computer executable code, when executed at a processor of a computing device, is configured to:
receive an instruction from a user, wherein the instruction is generated when a user views a media file corresponding to the product;
upon receiving the instruction, obtain a copy of the media file;
process the copy of the media file using a deep learning module to obtain an identification of the product; and
validate the product by comparing the identification of the product with a stored identification corresponding to the product.

In certain embodiments, the deep learning module includes:
a plurality of convolution layers sequentially in communication with each other, and each of the convolution layers is configured to perform convolution on the copy of the media file to generate feature maps having different scales, where each of the convolution layers is configured to extract features from the copy of the media file or the feature map from an immediate previous convolution layer to generate the corresponding feature map;
a detection module, configured to receive the feature maps with different scales from the plurality of convolution layers and generate intermediate identification of the product based on the feature maps; and
a non-maximum suppression module, configured to process the intermediate identifications of the product to generate the identification of the product.

In certain embodiments, the features comprise an image, at least one bounding box location, and at least one logo label corresponding to the at least one bounding box, and the deep learning module is trained using a plurality set of training data.

In certain embodiments, the computer executable code, when executed at the processor, is further configured to: when the identification of the product does not match with the stored identification of the product, send a notice to at least one of the user and a manager, such as the user and the manager of the e-commerce platform.

These and other aspects of the present invention will become apparent from following description of the preferred embodiment taken in conjunction with the following drawings and their captions, although variations and modifications therein may be affected without departing from the spirit and scope of the novel concepts of the invention.

### BRIEF DESCRIPTION OF THE DRAWINGS

The present invention will become more fully understood from the detailed description and the accompanying drawings. These accompanying drawings illustrate one or more embodiments of the present invention and, together with the written description, serve to explain the principles of the present invention. Wherever possible, the same reference numbers are used throughout the drawings to refer to the same or like elements of an embodiment, and wherein:

FIG. 1 schematically depicts a system for validating a product according to certain embodiments of the present invention.

FIG. 2 schematically depicts a validation application according to certain embodiments of the present invention.

FIG. 3A and FIG. 3B schematically depict a deep learning module according to certain embodiments of the present invention.

FIG. 4A and FIG. 4B schematically depict features of a product according to certain embodiments of the present invention.

FIG. 5 schematically depicts a system for validating a product according to certain embodiments of the present invention.

FIG. 6 schematically depicts a flowchart of a product validation method according to certain embodiments of the present invention.

FIG. 7 schematically depicts a flowchart of a deep learning method according to certain embodiments of the present invention.

FIG. 8 schematically depicts training of a deep learning module according to certain embodiments of the present invention.

FIG. 9 schematically depicts testing of a deep learning module according to certain embodiments of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers, if any, indicate like components throughout the views. Additionally, some terms used in this specification are more specifically defined below.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

Unless otherwise defined, all technical and scientific terms used herein have the same meaning as commonly understood by one of ordinary skill in the art to which this invention pertains. In the case of conflict, the present document, including definitions will control.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

As used herein, “plurality” means two or more. As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present invention.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present invention relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present invention will now be described more fully hereinafter with reference to the accompanying drawings, in which embodiments of the present invention are shown. This invention may, however, be embodied in many different forms and should not be construed as limited to the embodiments set forth herein; rather, these embodiments are provided so that this invention will be thorough and complete, and will fully convey the scope of the present invention to those skilled in the art.

In certain embodiments, counterfeit product may be identified using rule-based keywords matching. Specifically, the text description of the product is compared with a large product library. If the text matches that in the library, an agent will review the product to check if it is a counterfeit product. The disadvantage of the method is that: it is hard to set pre-configured rules; and the detection accuracy is low since the sellers can revise the text to avoid detection, and the rules are always limited.

In certain embodiments, counterfeit product may be identified using image feature matching. Specifically, the product image is compared with a pre-stored brand logo library. If the product image matches one or more logos in the library, a product with specific brands is detected. The image based approaches may use: hand-crafted features (such as scale invariant feature transform (SIFT), speeded up robust features (SURF), affine SIFT, histogram of oriented gradients (HOG)), affine transformation, and key points feature matching. The disadvantage of the method is that: it is hard to obtain consistent features from the images of the same product due to image distortion, different angles the pictures were taken, and different contextual environment; and the detection accuracy is low since hand-crafted features are not robust.

To overcome the above described disadvantages, certain embodiments of the present invention provides a deep learning based approach to detect logos in product images or videos (e.g. advertisement of the product or product introduction) and to further use the logos information for counterfeit product detection. The system is able to automatically send a notification to platform managers and customers who are looking at the product images or videos. As a result, the platform managers can takedown the products following their policies and the customers can avoid buying counterfeit products. This system can be implemented in mobiles, tablets and the cloud.

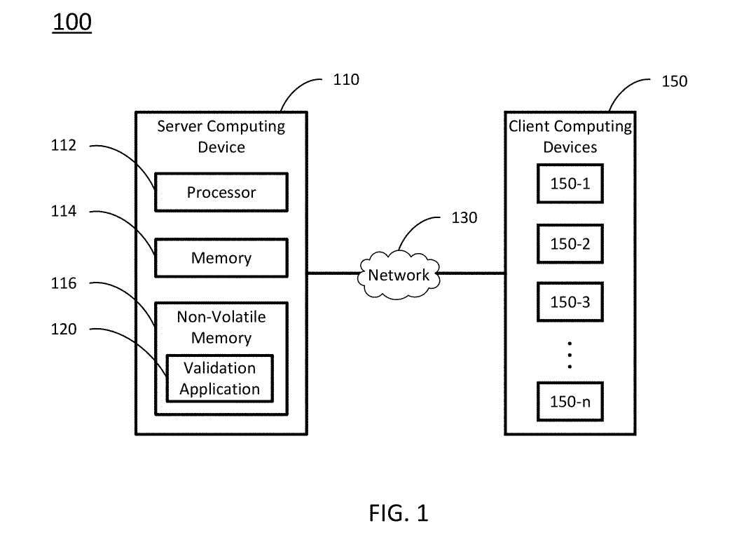

In accordance with the purposes of present invention, as embodied and broadly described herein, in certain aspects, the present invention relates to a system for validating a product to overcome the above described disadvantages. In certain embodiments, the product to be validated is listed in an-ecommerce platform. The system includes a server computing device, and multiple client computing devices in communication with the server computing device. FIG. 1 schematically depicts an exemplary system for validating a product according to certain embodiments of the present invention. As shown in FIG. 1, a system 100 includes a server computing device 110, and multiple client computing devices 150 in communication with the server computing device 110 through a network 130. In certain embodiments, the network 130 may be a wired or wireless network, and may be of various forms. Examples of the networks may include, but is not limited to, a local area network (LAN), a wide area network (WAN) including the Internet, or any other type of networks. The best-known computer network is the Internet. In certain embodiments, the network 130 may be an interface such as a system interface or a USB interface other than a network, or any other types of interfaces to communicatively connect the server computing device 110 and the client computing devices 150.

In certain embodiments, the server computing device 110 may be a cluster, a cloud computer, a general-purpose computer, or a specialized computer. In certain embodiments, the server computing device 110 provides e-commerce platform services. In certain embodiments, as shown in FIG. 1, the server computing device 110 may include, without being limited to, a processor 112, a memory 114, and a non-volatile memory 116. In certain embodiments, the server computing device 110 may include other hardware components and software components (not shown) to perform its corresponding tasks. Examples of these hardware and software components may include, but not limited to, other required memory, interfaces, buses, Input/Output (I/O) modules or devices, network interfaces, and peripheral devices.

The processor 112 may be a central processing unit (CPU) which is configured to control operation of the server computing device 110. The processor 112 can execute an operating system (OS) or other applications of the server computing device 110. In some embodiments, the server computing device 110 may have more than one CPU as the processor, such as two CPUs, four CPUs, eight CPUs, or any suitable number of CPUs.

The memory 114 can be a volatile memory, such as the random-access memory (RAM), for storing the data and information during the operation of the server computing device 110. In certain embodiments, the memory 114 may be a volatile memory array. In certain embodiments, the server computing device 110 may run on more than one memory 114.

The non-volatile memory 116 is a non-volatile data storage media for storing the OS (not shown) and other applications of the server computing device 110. Examples of the non-volatile memory 116 may include flash memory, memory cards, USB drives, hard drives, floppy disks, optical drives, or any other types of data storage devices. In certain embodiments, the server computing device 110 may have multiple non-volatile memory 116, which may be identical storage devices or different types of storage devices, and the applications of the server computing device 110 may be stored in one or more of the non-volatile memory 116 of the server computing device 110. The non-volatile memory 116 includes a validation application 120, which is configured to validate if a product is a possible counterfeit product. In certain embodiments, the product is listed on an e-commerce platform.

The client computing devices 150 may be a general-purpose computer, a specialized computer, a tablet, a smart phone, or a cloud based device. Each of the client computing devices 150 may include necessary hardware and software components to perform certain predetermined tasks. For example, the client computing device 150 may include a processor, a memory, and a non-volatile memory, which may be similar to the processor 112, the memory 114, and the non-volatile memory 116 of the server computing device 110. Further, the client computing devices 150 may include other hardware components and software components (not shown) to perform its corresponding tasks. The client computing devices 150 may include n client computing devices, namely, the first client computing device 150-1, the second client computing device 150-2, the third client computing device 150-3, . . . , and the nth client computing device 150-n. At least one of the client computing devices 150 runs a user interface for the user to access the product provided by the server computing device 110. In certain embodiments, the server computing device 110 provides the product through an e-commerce platform.

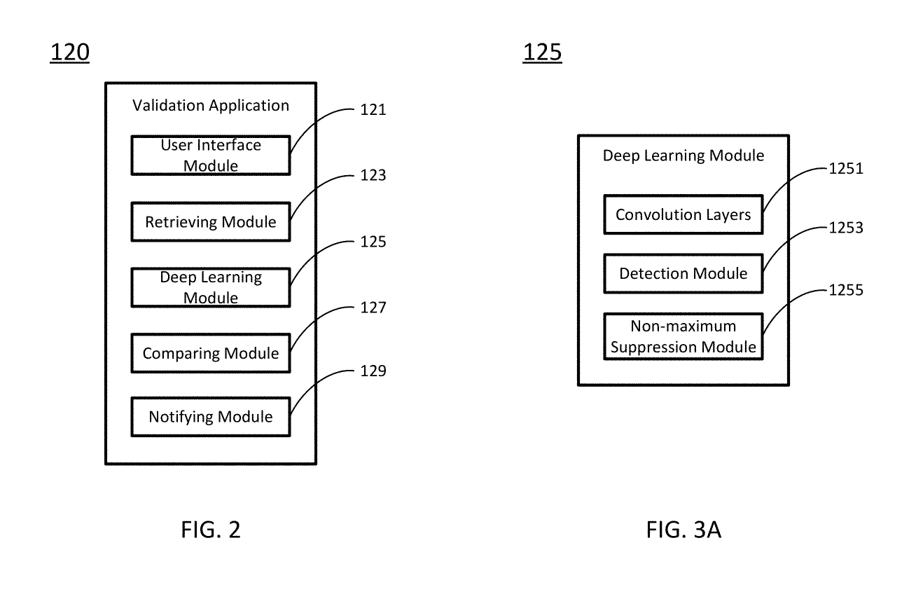

FIG. 2 schematically depicts the structure of the validation application according to certain embodiments of the present invention. As shown in FIG. 2, the validation application 120 may include, among other things, a user interface module 121, a retrieving module 123, a deep learning module 125, a comparing module 127, and a notifying module 129. In certain embodiments, the validation application 120 may not include the user interface module 121, and the function of the user interface module 121 is integrated into the e-commerce platform user interface provided by the server computing device 110. In certain embodiments, the validation application 120 may include other applications or modules necessary for the operation of the validation application 120. It should be noted that all of the modules of the validation application 120 are each implemented by computer executable codes or instructions, which collectively forms the validation application 120. In certain embodiments, each of the modules may further include sub-modules. Alternatively, some of the modules may be combined as one stack. In other embodiments, certain modules of the validation application 120 may be implemented as a circuit instead of executable code.

The user interface module 121 is configured to provide a use interface or graphic user interface in the client computing devices 150. When a user browses an e-commerce website, he may select an image or a video corresponding to a product. The action of select may be performed by click, tap, or any other suitable ways. For example, the image may be a photo of the product, and the video may be an advertisement of the product or a brief introduction of the product. In response to the selection or click operation of the user, the user interface sends an instruction to the retrieving module 123. The instruction may include a Uniform Resource Locator (URL) of a media file corresponding to the image or the video displayed at the client computing device, and the media file is preferably stored in the server computing device 110. The stored media file contains the same information of the image or the video viewed by the user. In other words, both the web browsing and the retrieving by the retrieving module 123 are performed from the same media file that is stored in the service computing device 110. Alternatively, the instruction may itself include the image or the video, so that the retrieving module 123 can retrieve the media file directly from the instruction.

The retrieving module 123 is configured to retrieve a copy of the media file from the server computing device 110 according to the instruction received from the user interface module 121, or alternatively retrieve a copy of the media file directly from the instruction. In certain embodiments, the retrieval module 123 preferably retrieves the copy of the media file from the server computing device 150. In other embodiments, when the validation application 120 is installed on the client computing device 150, the retrieving module 123 may retrieve the copy of the media file from the client computing device 150. That is, when the user brows the product on the e-commerce website, the client computing device 150 receives the media file from the server computing device 150, and the received media file can be used to show the image or the video on the browser and at the same time or sequentially, can be used by the retrieving module 123 for further processing. After retrieval, the retrieving module 123 sends the media file to the deep learning module 125 for further processing.

The deep learning module 125 is configured to process the media file received from the retrieving module 123, and obtain a result-an identification of the product, such as a brand name of the product. The deep learning module 125 may use region-based convolutional neural network (R-CNN), faster R-CNN, you only look once (YOLO), single shot multibox detector (SSD) etc., which are not used in counterfeit product determination. The deep learning module 125 may also be named as a deep learning model.

The comparing module 127 is configured to, upon receiving the obtained identification of the product from the deep learning module 125, retrieve the stored identification of the product from the server computing device 110, and compare the obtained identification with the retrieved identification. The stored identification may be previously provided by the seller of the product during registration of his store or his product for sale. When the obtained identification and the retrieved identification matches, the system may not do anything further, or may store the validation result to the server database. When the obtained identification doesn't match the retrieved identification, the mismatch is then sent to the notifying module 129.

The notifying module 129 is configured to, in response to receiving the mismatch information from the comparing module 127, prepare and send a notification to the e-commerce platform manager, or prepare and send a notification to the e-commerce platform user, or both. The notification usually contains a warning message about the possible counterfeit of the product.

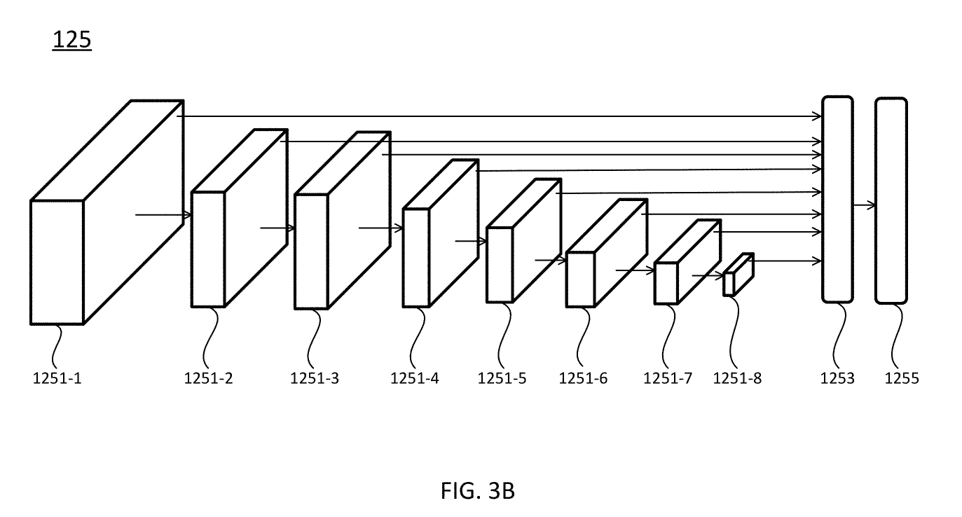

As shown in FIG. 3A and FIG. 3B, the deep learning module 125, includes multiple convolution layers 1251, a detection module 1253, and a non-maximum suppression (NMS) module 1255.

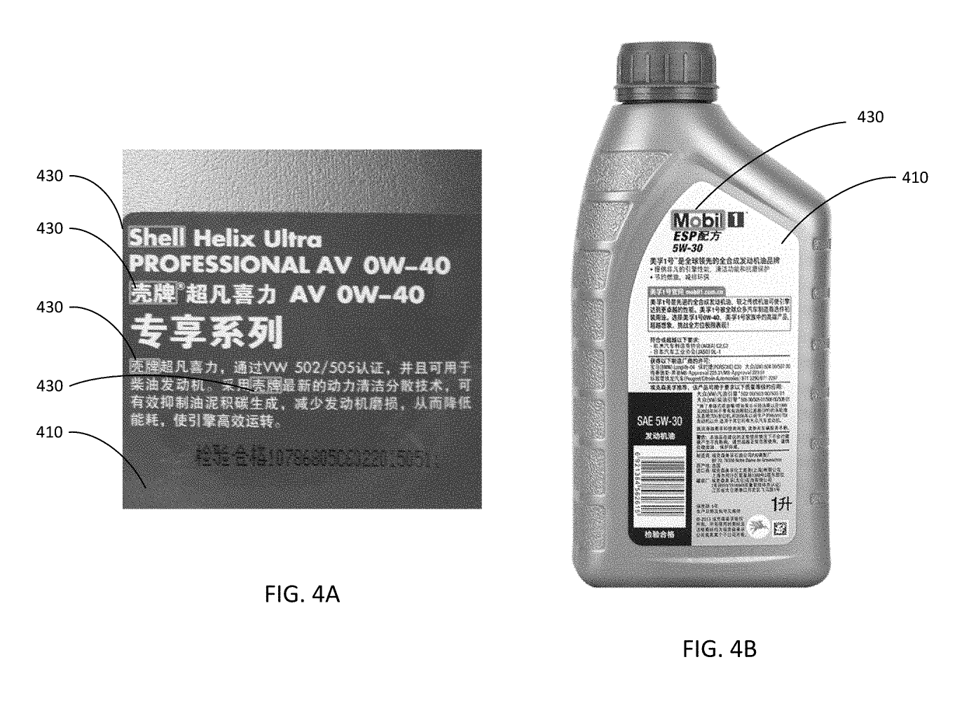

The convolutional layers 1251 is configured to extract features of the media file at multiple scales from fine to coarse (from left to right layers in FIG. 3B). The number of layers could vary from 5 to 1000 depending on the specific applications. In certain embodiments, the number of convolution layers is about 10-200. In certain embodiments, the number of convolution layers is about 20-50. In one embodiment, the number of convolution layers is about 30. In certain embodiments, the convolution layers may be grouped into several convolution layer groups, and each of the convolution layer group may include 1-5 convolution layers that have similar characteristics, such as using similar parameters for the convolution. The extracted features may include the bounding box locations on the image corresponding to the media file and the corresponding logo labels. For example, as shown in FIG. 4A and FIG. 4B, a media file may include an image 410 of a product. One or more bounding boxes 430 are determined from the image 410. The locations of the bounding boxes 430 may be defined by X, Y coordinate, size and shape. In this example, each of the bounding boxes 430 has a shape of rectangular. In other embodiment, the bounding box 430 may have other types of shapes, such as an oval or a circle. The information shown in the bounding boxes is a logo label, which may include the brand name of the product, or the specific product name of the product. The logo label may be a plain text of the brand name or a logo image of the brand. Once those features are defined, the features are sent to the convolution layers 1253 for recognition.

Referring back to FIG. 3B, the features of the image are extracted by the convolution layers from left to right, from fine to coarse, the extracted features from the convolution layers may be in a form of feature maps. Each feature map generated by the corresponding convolution layer may have features corresponding to one or more bounding boxes and labels of the bounding boxes. In certain embodiments, the convolution layers 1251 include 5-1000 convolution layers depending on the specific applications. In certain embodiments, the number of convolution layers is about 10-150. In certain embodiments, the number of convolution layers is about 30. Each of the convolution layers 1251 includes different number of parameters, weights or bias, depending on the structure of the deep learning model. In the example as shown in FIG. 3B, the convolution layers 1251 include eight convolution layers, that is, the first convolution layer 1251-1, the second convolution layer 1251-2, the third convolution layer 1251-3, the fourth convolution layer 1251-4, the fifth convolution layer 1251-5, the sixth convolution layer 1251-6, the seventh convolution layer 1251-7, and the eighth convolution layer 1251-8. In certain embodiments, the convolution layers 1251 have less and less parameters from convolution layer 1251-1 to 1251-8, and the processing speed is faster and faster from convolution layers 1251-1 to 1251-8. The first convolution layer 1251-1 receives the copy of the media file, and performs the convolution to generate a first feature map. In certain embodiments, the first convolution layer 1251-1 may also be a group of 3-4 convolution layers that has similar parameters. The second convolution layer 1251-2 receives the first feature map, and performs convolution to obtain the second feature map, the second feature map . . . The eighth convolution layer 1251-8 receives the seventh feature map from the seventh convolution layer 1251-7, performs convolution on the seventh feature map, to generate the eighth feature map. In certain embodiments, the parameters from 1251-1 to 1251-8 are less and less, and the feature maps from the first to the eighth are from fine to coarse.

The outputs from the convolution layers 1251, i.e., the feature maps, are sent to or retrieved by the detection module 1253, so that the detection module 1253 generates or filter out one or multiple candidate locations of the identifications of the product, such as brand name or logo images. Those processed candidate identifications may also be named intermediate identification of the products. In certain embodiments, the intermediate identifications of the product may include 100-2000 bounding boxes and optionally their corresponding labels. In certain embodiments, the parameters of the parameters of the detection module 1253 and/or the parameters of the convolutional layers 1251 are adjusted to have 300-1000 bounding box candidates. In one embodiments, the parameter is adjusted to have about 800 bounding box candidates. The intermediate identification, i.e., the one or more identifications of the product, are then used as input for the NMS module 1255.

The NMS module 1255 is configured to process the intermediate identifications generated by the detection module 1253, and output one identification of the product as the final result of the deep learning module 125. In certain embodiments, the NMS module 1255 may combine certain overlapping intermediate identifications, sort the intermediate identifications according to certain criteria, and choose a small number of intermediate identifications from the top of the sorted list. In one embodiment, the detection module 1253 generates a large number of potential bounding boxes, and upon receiving those large number of bounding boxes (intermediate identifications), the NMS module 1255 uses a confidence threshold of 0.05 to filter out most of the bounding boxes, and then applies the NMS with jacquard overlap of 0.5 per class, to obtain the bounding boxes with the highest scores. Here each class represents a same type of objects in the image. Several bounding boxes having only words inside the boxes may be classified as one class, and several bounding boxes having only images inside the boxes may be classified as one class, and several bonding boxes having both words and images may be classified as one class.

During the training phase of the deep learning module, based on the quality of the result from the NMS module 1255, the result can then be back propagated to adjust the parameters of at least one of the convolution layers 1251, the detection module 1253, and the NMS module 1255, so as to improve the accuracy and efficiency of the deep learning module 125. The resulted identification from the NMS module 1255 of the deep learning module 125 is then sent to the comparing module 127 for further processing. The identification can be, for example, a brand name.

The above described extracting features through the convolutional layers, detecting candidate identifications of the product, obtaining one identification of the product, and adjusting parameters based on the quality of the identification may be performed using certain amount of training data to obtain a well-trained deep learning module 125, so that the well-trained module 125 can be used for the above described product validation.

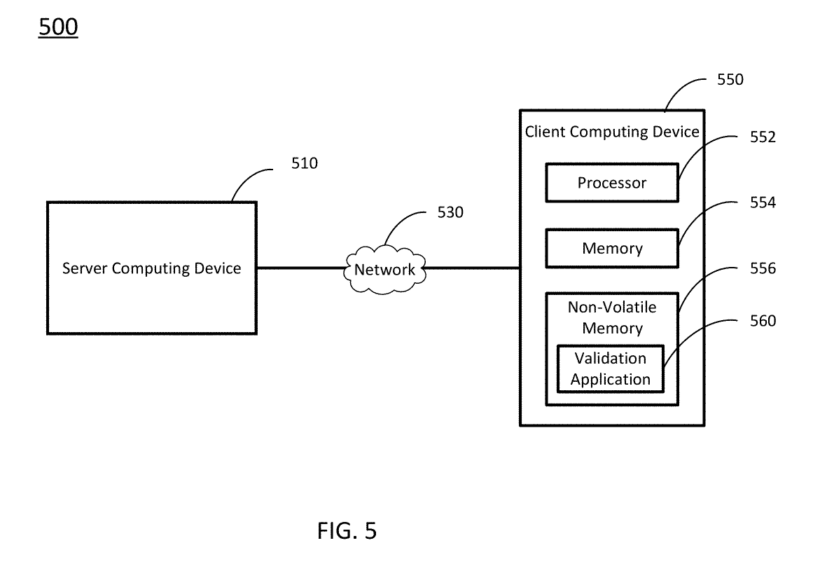

In certain embodiments, the validation application may be located in the client computing device 150 instead of the server computing device 110. As shown in FIG. 5, the system 500 includes a server computing device 510, and one or more client computing devices 550 in communication with the server computing device 510 through a network 530. The client computing device 550 includes a process 552, the memory 554 and a non-volatile 556, which may be similar to the processor 112, the memory 114, and the non-volatile memory 116 of the server computing device 110. The non-volatile memory 116 stores a validation application 560. The structure and function of the validation application 560 are the same as or similar to the structure and function of the validation application 120 of the server computing device 110. In this embodiment, the validation application 560 may use a copy of the image or video shown in the client computing device 550 instead of retrieving a copy of the image or video from the server computing device 510.

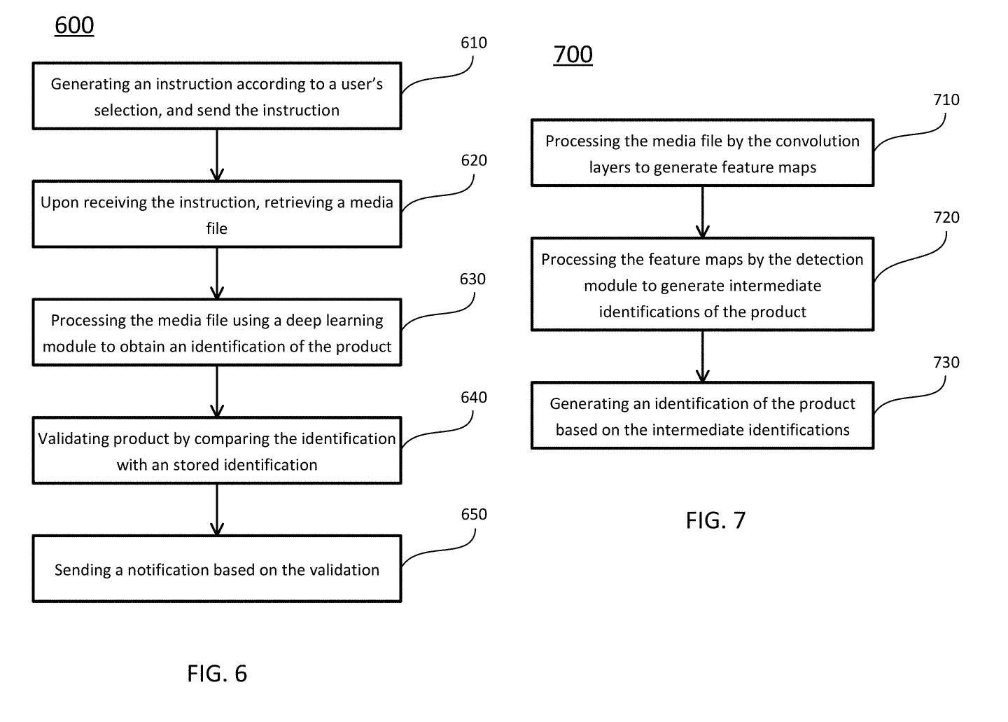

In certain aspects, the present invention relates to a method for validating a product. FIG. 6 schematically depicts a flowchart 600 showing a method of validating a product in an e-commerce platform according to certain embodiments of the present invention. In certain embodiments, the method as shown in FIG. 6 may be implemented on a system as shown in FIG. 1. It should be particularly noted that, unless otherwise stated in the present invention, the steps of the method may be arranged in a different sequential order, and are thus not limited to the sequential order as shown in FIG. 6. Further, the method is exemplified by using products listed in one or more e-commerce platforms. However, the method according to certain embodiments of the present invention is not limited to e-commerce platform, but is usable to process any products that are represented using pictures.

In this example, the validation application 120 is part of the server computing device 110, and the user interface module 121 is an integrated part of the user interface of the service computing device 110, that is, the e-commerce user interface or the e-commerce website. Alternatively, the validation application 120 is independent from the server computing device 110, and the user interface module 121 is linked to the user interface of the service computing device 110, such that a selection or click of certain image or video of a product triggers the operation of the user interface module 121.

Specifically, when a user uses a browser of a computer, a tablet, a smartphone or a cloud-based device to search or browse products in the e-commerce website, he may open a webpage of the product or a listed of products. If the user finds the product he is interested in, he may click a title image of the product or click to play a short video about that product. Consequently, in step 610, in response to the user's click or selection of the product title image or video, the user interface module 121 generates an instruction. The instruction may include a URL of the title image or the video, or alternatively, contain a copy of the title image or the video within the instruction. The instruction was then sent from the user interface to the retrieving module 123.

In step 620, upon receiving the instruction, the retrieving module 123 obtains the URL from the instruction, and retrieves a copy of a media file from the server computing device 110 according to the URL. The copy of the media file corresponds to the title image or the short video. Actually, the retrieved copy of the media file and the title image or the short video clicked by the user come from the same media file or a copy of the same media file. In certain embodiments, the retrieving module 123 may also retrieve a stored identification of the product, and after retrieval, send the stored identification to the comparing module 127. The stored identification may be a brand name, a logo image, or any other identifications of the product that is stored in the server computing device 110. The stored identification normally is uploaded by the seller of the product when the seller registered his store or his product, as normally required by an e-commerce platform.

The retrieved media file is sent to the deep learning module 125, and in step 630, the deep learning module 125 processes the retrieved media file to obtain an identification of the product. The detailed processing steps are illustrated in FIG. 6 and described later in this application.

In step 640, the obtained identification of the product by the deep learning module 125 is compared with the stored identification of the product for validation. The stored identification of the product may be received from the retrieving module 123 at step 620, or may be retrieved directly by the comparing module 127 in advance in response to receiving of the instruction, or may be retrieved from the server computing device 110 in response to receiving the obtained identification of the product. After comparing the identification obtained by the deep learning module 125 and the stored identification retrieved from the server computing device 110, the result, either the two match or mismatch, is obtained at the comparing module 127. When the obtained identification matches the stored identification, the comparing module 127 may not do anything or optionally send the match information to the notifying module 129. When the obtained identification and the stored identification mismatch, the comparing module 127 send the mismatch information to the notifying module 129.

In step 650, upon receiving the mismatch information, the notifying module 129 prepares a notification, to at least one of an e-commerce platform manager or the user, warning the mismatch of the obtained identification and the stored identification. The mismatch may indicate possible counterfeit of the product.

FIG. 7 schematically depicts a flowchart 700 of a deep learning method according to certain embodiments of the present invention, that is, the step 630. As shown in FIG. 7, when the deep learning module 125 receives the media file from the retrieving module 123, in step 710, the convolutional layers 1251 extract features from the media file. The extracted features by the convolution layers 1251 may be in the form of feature maps, and the features in each of the feature maps may correspond to locations of one or more bounding boxes, and logo label or brand name corresponding to the bounding boxes.

In step 710, the features of image are extracted by the convolution layers 1251. The different convolution layers 1251 may contain different amount of parameters or different combination of those parameters. The features from different layers usually include different scales of the features of the images. For example, the first convolution layer 1251-1 receives the raw image as input to extract features and generate the first feature map, and each of the following convolution layers 1251 receives the output—the feature map—from the immediate previous convolution layer 1251 as the input to extract features and generate the corresponding feature map. The sequentially aligned convolution layers 1251 may have coarser and coarser features outputs from the convolution layers 1251-1 to 1251-8. This fine-to-coarse, multi-scale features can dramatically improve the robustness and accuracy of the model. At certain convolution layers, the output may be converged, and thereafter the output from the following convolutions layers may not be obviously different from each other.

In step 720, the outputs from the convolution layers 1251, i.e., the feature map from each of the convolution layers 1251, are sent to the detection module 1253, or alternatively, the detection module 1253 actively detect or retrieve the feature maps from the convolution layers 1251. Based on those output, the detection module 1253 generates or filter out one or more intermediate identifications of the product, such as candidates of a brand name and/or logo images. The one or more intermediate identifications of the product are then used as input of the NMS module 1255 for further result refinement.

In step 730, the NMS module 1255 processes the one or more intermediate identifications generated by the detection module 1253, and output an identification of the product as the final result by the deep learning module 125. The resulted identification from the NMS module 1255 of the deep learning module 125 is then sent to the comparing module 127 for further processing. The identification of the product can be, for example, a brand name. In certain embodiment, upon receiving those large number of bounding boxes (intermediate identifications), the NMS module 1255 uses a confidence threshold of 0.05 to filter out most of the bounding boxes (alternatively, the filtering process can also be placed in the detection module), and then applies the NMS with jacquard overlap of 0.5 per class, to obtain the bounding boxes with the highest scores. Based on the several bounding boxes with the highest score, which may correspond to the same identification or the same brand, the identification of the product is obtained as a final result.

Based on the quality of the result from the deep learning module 125 or the comparing module 127, the method may further include a step of adjusting parameters of the convolution layers 1251, the detection module 1253, and the NMS module 1255 according to the final result, so as to improve the accuracy and efficiency of the deep learning module 125.

In certain embodiments, the design and application of the deep learning module 125 may include the steps of building the deep learning module 125, training the deep learning module 125, and using the well-trained deep learning module 125. FIG. 8 shows a process of training a deep learning module. Once the deep learning module 125′ is built, well defined training data 810 are used as input to train the deep learning module. The training data 810 may be the one as shown in FIG. 4A and FIG. 4B. The training data 810 include the image, the locations of the bounding boxes, and the logo label of the bounding boxes. The deep learning module 125′ obtains an identification of the training product using the training data 810. The obtained identification from the deep learning module 125′ is evaluated, and the evaluation is used as feedback to adjust the parameters of the deep learning module 125′. Certain amount of training data may be used to get a well-trained deep learning module 125.

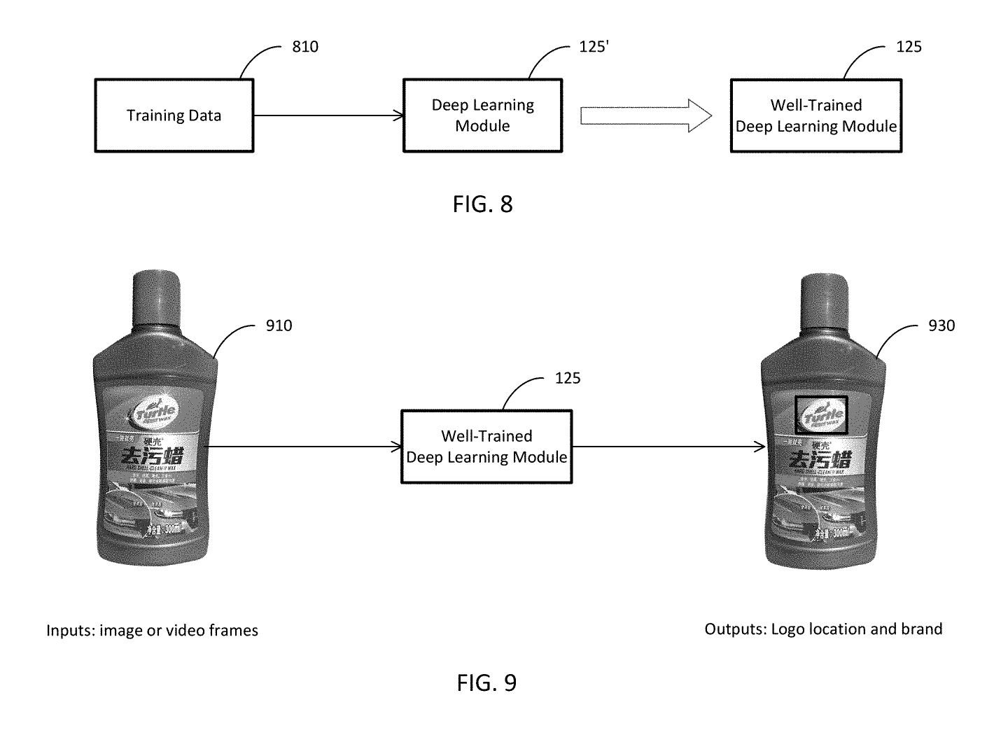

After the deep learning module 125 is well-trained, it can be tested using data that are different from the training data. As shown in FIG. 9, the image or one or more video frames 910 are used as input of the well-trained deep learning module. The image or frames 910 are used directly as input without defining bounding boxes or logo labels. The well trained deep learning module 125 can then identify the logo location defined by one or more bounding boxes, and provide an identification of the product, such as a brand name, or locations of the logos. Those result will then be used to be compared with stored identification of the product in the e-commerce platform server.

In certain aspects, the present invention relates to a non-transitory computer readable medium storing computer executable code. In certain embodiments, the computer executable code may be the software stored in the non-volatile memory 116 as described above. The computer executable code, when being executed, may perform one of the methods described above. In certain embodiments, the non-transitory computer readable medium may include, but not limited to, the non-volatile memory 116 of the computing device 110 as described above, or any other storage media of the computing device 110.

In certain aspects, the deep learning model can be continuously improved by adding more training images or videos, or improved through the usage of the deep learning model.

In certain aspects, the deep learning model can be used as an application programming interface (API) service by third party platforms for counterfeit product detection.

Certain embodiments of the present invention, among other things, provide: (1) a deep learning approach for logo detection in images and videos; and (2) a counterfeit product detection system including the deep learning module or a deep learning model. The system can be implemented in mobile device, tablet, and the cloud. Further, the system can send a notification to the platform manager and customers when a counterfeit product is detected. In addition, the detection of counterfeit product is a real-time detection which provides information immediately and saves cost. Further, the deep learning module of the present invention uses multi-scale feature maps, which improves the efficiency and accuracy of the obtained identification of the product.

Certain embodiments of the present invention do not need hand-crafted features, which makes our embodiments more robust and less sensitive to data from different sources. Further, certain embodiments of the present invention use a one-stage approach which does not need explicit region proposals during model training, thus it is faster and can be used for real-time logo detection. Moreover, certain embodiments of the present invention do not need the image matching step, and the deep learning model can be deployed in the cloud, mobile phone or tablets. In addition, certain embodiments of the present invention do not need a pre-assembled database of brand names, logos, or logo images, and occupy a small space and operate easily and fast.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

### REFERENCES

1. Alessandro Prest, Recognition process of an object in a query image, U.S. Pub. No. 2016/0162758 A1, 2016.
2. Zenming Zhang and Depin Chen, System and method for determining whether a product image includes a logo pattern, U.S. Pub. No. 2017/0069077 A1, 2017.
3. Matthias Blankenburg, Christian Horn, and Jorg Kruger, Detection of counterfeit by the usage of product inherent features, Procedia CIRP 26, 420-435, 2015.
4. Hang Su, Xiatian Zhu and Shaogang Gong, Deep learning logo detection with data expansion by synthesising context, IEEE winter conference on applications of Computer Vision, 2017.
5. Steven C. H. Hoi, etc. Logo-net: large-scale deep logo detection and brand recognition with deep region-based convolutional networks, arXiv:1511.02462, 2015.

What is claimed is:

1. A system for validating a product, the system comprising a computing device, the computing device comprising a processor and a non-volatile memory storing computer executable code, wherein the computer executable code, when executed at the processor, is configured to:
receive an instruction from a user, wherein the instruction is generated when a user views a media file corresponding to the product;
upon receiving the instruction, obtain a copy of the media file;
process the copy of the media file using a deep learning module to obtain an identification of the product; and
validate the product by comparing the identification of the product with a stored identification corresponding to the product
wherein the deep learning module comprises:
a plurality of convolution layers sequentially in communication with each other, and configured to perform convolution on the copy of the media file to generate feature maps having different scales, wherein each of the convolution layers is configured to extract features from the copy of the media file or the feature map from an immediate previous one of the convolution layers to generate the corresponding feature map;
a detection module, configured to receive the feature maps with different scales from the plurality of convolution layers and generate intermediate identifications of the product based on the feature maps; and
a non-maximum suppression module, configured to process the intermediate identifications of the product to generate the identification of the product.

2. The system of claim 1, wherein the features comprise an image, at least one bounding box location, and at least one logo label corresponding to the at least one bounding box.

3. The system of claim 1, wherein the deep learning module is trained using a plurality set of training data, wherein each set of the training data comprises an image, at least one bounding box location in the image, and at least one logo label corresponding to the at least one bounding box.

4. The system of claim 1, wherein the product is listed in an e-commerce platform.

5. The system of claim 4, wherein the computing device is at least one of a server computing device and a plurality of client computing devices, the server computing device provides service of the e-commerce platform, and the client computing devices comprises a smartphone, a tablet, a laptop computer, and a desktop computer.

6. The system of claim 5, wherein the copy of the media file is obtained from the server computing device.

7. The system of claim 4, wherein the computer executable code, when executed at the processor, is further configured to:
when the identification of the product does not match with the stored identification of the product, send a notice to at least one of the user and a manager of the e-commerce platform.

8. The system of claim 1, wherein the instruction is generated when a user clicks an image or a video corresponding to the media file.

9. The system of claim 1, wherein the identification of the product comprises a brand name or a logo image of the product.

10. A method for validating a product, comprising:
receiving an instruction at a computing device, wherein the instruction is generated when a user views a media file corresponding to the product;
upon receiving the instruction, obtaining a copy of the media file;
processing the copy of the media file using a deep learning module to obtain an identification of the product; and
validating the product by comparing the identification of the product with a stored identification corresponding to the product,
wherein the processing the copy of the media file comprises:
performing convolution on the copy of the media file to generate feature maps having different scales by a plurality of convolution layers sequentially in communication with each other, wherein each of the convolution layers extracts features from the copy of the media file or the feature map from an immediate previous one of the convolution layers to generate the corresponding feature map;
receiving and processing the feature maps with different scales, to generate intermediate identifications of the product; and
processing the intermediate identifications to generate the identification of the product.

11. The method of claim 10, wherein the features comprise an image, at least one bounding box location, and at least one logo label corresponding to the at least one bounding box.

12. The method of claim 10, further comprising:
training the deep learning module using a plurality set of training data, wherein each set of the training data comprises an image, at least one bounding box location in the image, and at least one logo label corresponding to the at least one bounding box.

13. The method of claim 10, wherein the product is listed in an e-commerce platform.

14. The method of claim 13, wherein the computing device is at least one of a server computing device that provides the e-commerce platform, and a plurality of client computing devices, and the client computing devices comprise a smartphone, a tablet, a laptop computer, and a desktop computer.

15. The method of claim 14, wherein the copy of the media file is obtained from the server computing device.

16. The method of claim 13, further comprising:
when the identification of the product does not match with the stored identification corresponding to the product, send a notice to at least one of the user and a manager of the e-commerce platform.

17. A non-transitory computer readable medium storing computer executable code, wherein the computer executable code, when executed at a processor of a computing device, is configured to:
receive an instruction from a user, wherein the instruction is generated when a user views a media file corresponding to a product;
upon receiving the instruction, obtain a copy of the media file;
process the copy of the media file using a deep learning module to obtain an identification of the product; and
validate the product by comparing the identification of the product with a stored identification corresponding to the product,
wherein the deep learning module comprises:
a plurality of convolution layers sequentially in communication with each other, and configured to perform convolution on the copy of the media file to generate feature maps having different scales, wherein each of the convolution layers is configured to extract features from the copy of the media file or the feature map from an immediate previous one of the convolution layers to generate the corresponding feature map;
a detection module, configured to receive the feature maps with different scales from the plurality of convolution layers and generate intermediate identification of the product based on the feature maps; and
a non-maximum suppression module, configured to process the intermediate identifications of the product to generate the identification of the product.

18. The non-transitory computer readable medium of claim 17, wherein the features comprise an image, at least one bounding box location, and at least one logo label corresponding to the at least one bounding box, and the deep learning module is trained using a plurality set of training data.

19. The non-transitory computer readable medium of claim 17, wherein the product is listed in an e-commerce platform.

20. The non-transitory computer readable medium of claim 17, wherein the computer executable code, when executed at the processor, is further configured to:
when the identification of the product does not match with the stored identification of the product, send a notice to at least one of the user and a manager of the e-commerce platform.
